(19) United States
(12) Patent Application Publication
(10) Pub. No.: US 2006/0238539 A1
(43) Pub. Date: Oct. 26, 2006

(54) Method and apparatus for glyph hinting by analysis of similar elements

(76) Inventor: David G. Opstad, Mountain View, CA (US)

Correspondence Address: BREINER & BREINER, L.L.C., P.O. BOX 19290, ALEXANDRIA, VA, 22320-0290, US

(21) Appl. No.: 11/109,723

(22) Filed: Apr. 20, 2005

(51) Int. Cl. G06T 11/00

(52) U.S. Cl. 345/469

(57) ABSTRACT

A method for grouping glyphs or characters together by certain characteristics, and then mechanically performing hinting on each group based on the hand-done hinting of an avatar character or glyph in each class, and then reusing this hinting for other glyphs or characters is disclosed.

### BACKGROUND OF THE INVENTION

The representation of typographic data in digital form involves two well-known problems.

The first is the loss of detail accuracy that occurs in the transfer of the (analog) “master” design created by a typeface design artist to digital form. Quantization effects, even at very high scanning resolutions, provide visual distortion of otherwise smoothly flowing lines. As a result, the close approximation of the “master” by a dataset of originally-scanned data requires a very large amount of storage. In the earliest forms of digital typography, for example, storage and display methods were based upon bitmaps, which are simple to store, retrieve, and display. An alternate approach is to convert the originally-scanned quantized data into a connected set of mathematically-defined boundaries of two-dimensional regions representing the “inside” or “outside” of a character. The boundaries are comprised of “curve elements” that, in the most primitive implementations, are simple line segments.

The second problem relates to how the digitally defined letterforms are overlayed onto the two-dimensional raster “grid” on which the result is to be rendered. At lower resolutions such as those used for current “desktop” printing and video display devices, simple scaling of the character outlines produces unacceptable results. The problem is manifested in the scaling of mathematically-defined character outlines to low point sizes relative to the raster grid. Common misalignment effects include loss of symmetry or “stem dropout” within individual characters, the different appearance of supposedly identical character shapes due to differing phase with respect to the grid, and misalignment of a (horizontal) line of text or of a (vertical) column of characters.

The “low resolution” problem of digital typography has been addressed by the methodology hereinafter referred to as hint-based scaling in which “hints”, which are also sometimes referred to as “instructions” or “intelligence”, are added to characterize or specify key features of the letterforms to ensure they behave consistently when displayed. For example, the widths of the stems of a lower case “m” could be required to be the same number of pixels to be properly readable at small sizes. Hints improve the consistency of letterform shapes and their alignment when rasterized.

Hinting is well described in Hawkins U.S. Pat. No. 4,675,830 (incorporated herein by this reference). The process developed in the Hawkins patent, along with others aimed at similar objectives, overrides the normal scaling process and repositions many of the points of the character outline boundaries (thereby causing some pixels that would otherwise be “off” to be turned “on” and vice versa). This repositioning is meant to produce a more pleasing and harmonious collection of text characters at any given size and output resolution.

The hinting process is based upon data that are added to the character outline. This establishes standard relationships that are globally defined for a given typeface design, along with those within individual characters. The hint data are used to adjust the shape of the contour of each character to fit the output grid as it is rendered. A successful implementation of this methodology is the INTELLIFONT® scaleable font database. Variations on the technique can be found/in the POSTSCRIPT® “Type 1” font scaling technology offered by Adobe Systems Inc. and the TRUETYPE® font system offered by Apple Computer, Inc. and Microsoft, Inc. These technologies have in common the fact that additional data are included for every scalable font, and for every character of a scalable font, to provide the hint data. Moreover, a considerable amount of effort is spent in designing and applying this hint data to the character outlines meant for general use in computing systems.

### OBJECTS AND SUMMARY OF THE INVENTION

Often, these hints are generated “manually.” That is, hints for each letterform are estimated, often by computer analysis. However, before the font is published or made available, validity of the hints is confirmed by observing how the encoded letterform scales and renders to ensure that, at the different scales, the font appears and is perceived as the same as the original analog version. The hints are often then manually or “hand-tuned” to improve their rendition.

Manually generating and confirming hints in a character-based font such as a Chinese, Japanese, or Korean (CJK) font is a large-scale and time-intensive task, however. Hinting a font containing CJK glyphs is a fundamentally different task than hinting a Latin or other alphabetic font. On one hand, the glyph repertoires of such fonts tend to be large, usually many tens of thousands. This means hand-tuning hints is almost prohibitively expensive. Moreover, each character tends to be more complex and has a greater number of strokes than a typical letterform from an alphabetic font.

The shapes of the glyphs as influenced by thousands of years of their development lend themselves well to component-based approaches, however. Such component-based approaches are used to encode glyph data within fonts. For example, when using TRUETYPE® font technology, a font can be constructed of components, and then a large percentage of the CJK glyphs represented as composites of these components.

The present invention concerns a method for grouping glyphs or characters together by certain characteristics, and then mechanically performing hinting on each group based on the hand-done hinting of an avatar character or glyph in each class, and then reusing this hinting for other glyphs or characters.

In general, according to one aspect, the invention features a method for generating hints in character-based fonts. This method comprises grouping characters into classes based on elements within the characters. Then, representative, avatar characters are selected for each one of these classes. Hints are then generated for the elements of the avatar characters. These hints, which are synonymously referred to as intelligence or instructions, control how the elements are rendered based on the scaling or the resolution at which they are intended to be rendered. These generated hints from the avatar characters are then applied to other characters in the classes.

Depending on the implementation, the characters are Chinese, Korean, and/or Japanese characters.

The step of grouping preferably comprises grouping characters into classes based on elements in the characters. Specifically, characters in the same group will have a common element.

In one embodiment, the step of determining whether elements from different characters are similar is based on an expected number of pixels per “M”, hereinafter pixels-per-EM or ppem, for target rendering resolutions, for the expected rendering application. In some examples, numbers of classes are tagged based on whether the assignment to the classes is valid for all, such as larger, pixels-per-EM applications. In the common example, some characters belong to more than one class. Thus, they refer to avatar characters for different elements of the characters.

Preferably, the hints for the elements of the avatar characters are generated or reviewed manually, that is, by an operator.

In general, according to another aspect, the invention features a software product for encoding character-based fonts. The product comprises a computer-readable medium in which instructions are stored. These instructions, when read by a computer, cause a computer to group characters into classes based on elements within the characters and then select representative, avatar characters for each one of the classes.

Hints are then generated for the elements of the avatar characters and these hints are applied to other characters in the classes.

In general, according to another aspect, the invention features the font system for storing character-based font information. This font system comprises description information for elements of avatar characters. This description information in the typical embodiment is hints, instructions, and/or intelligence. References to the description information for the elements in other characters containing the same elements are made.

In this way, hints only need to be generated for the avatar characters. Moreover, the data footprint required to store the font information is reduced by using the references.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Referring to the drawings:

FIG. 1 illustrates a glyph classification process for encoding or generating glyph rendering information;

FIG. 2 illustrates an exemplary class of glyphs that each includes a knife radical repeating element;

FIG. 3 illustrates a glyph classification process according to the present invention;

FIG. 4 illustrates a set of glyphs that could be initially placed in the same class due to the presence of the radical but are further subclassed according to one embodiment of the present invention;

FIG. 5 illustrates a class of glyphs that all share a “left-side earth radical” glyph element and are grouped according to the present invention;

FIG. 6 illustrates a class of glyphs that all share a “right-side ye” glyph element and are grouped according to the present invention;

FIG. 7 illustrates the process of hinting the avatar glyph according to the present invention;

FIG. 8 shows a selected avatar glyph for the “earth” glyph element;

FIG. 9 is a pseudo code description of aspects of the invention; and

FIG. 10 illustrates the organization of a font database according to the principles of the present invention.

### DETAILED DESCRIPTION OF THE PREFERRED EMBODIMENTS

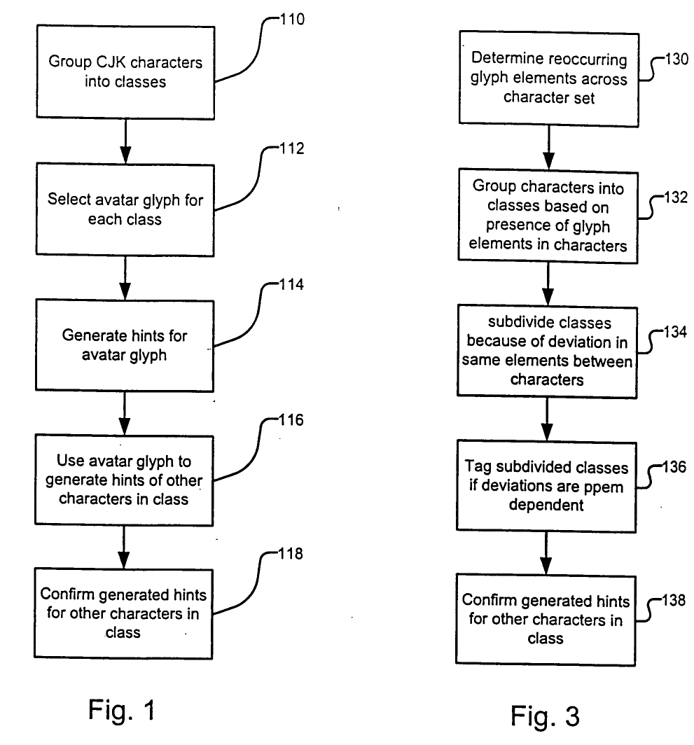

FIG. 1 illustrates a glyph classification process for encoding or generating glyph rendering information, such as hints, instructions, or intelligence, by analysis of similar elements, according to the present invention.

Generally, the process comprises a series of steps:

A. The CJK characters are first grouped together into classes, using mostly font independent sources of information, step 110.

B. An avatar glyph is then selected in each class, step 112, and it is manually hinted for all pixels-per-EM values, step 114.

C. Using the data from the two previous steps, the avatar's hints are applied to all other glyphs in its class in step 116. The process is repeated for all the classes.

D. The output of step C is then checked and corrections made, either individually to glyphs or overall to the process in step 118.

In more detail, because of the heavy use of repeated elements in many CJK glyphs, the characters or glyphs are able to be grouped together into classes based on similar characteristics.

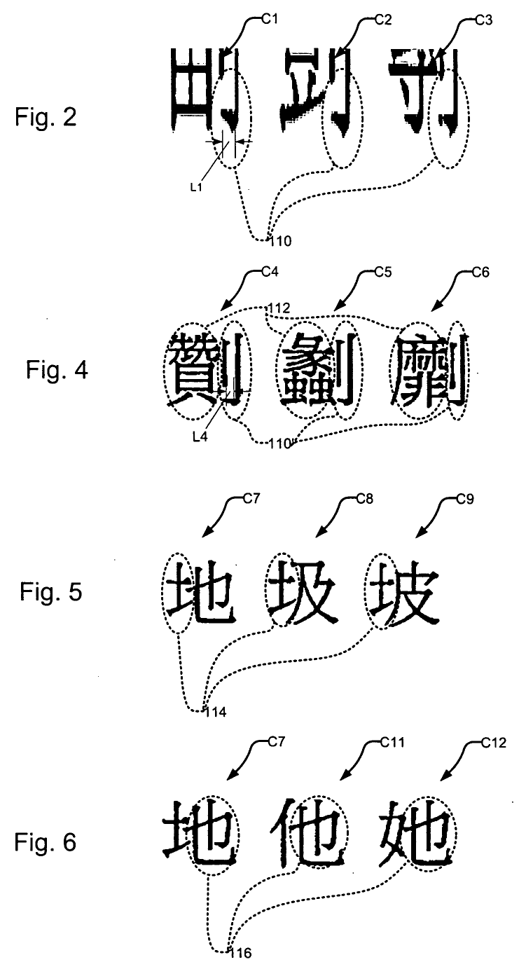

FIG. 2 illustrates an exemplary class of glyphs C1, C2, C3, that each includes a knife radical repeating element 110.

Notice that in all these glyphs C1, C2, C3, the repeating element 110 on the right (the knife radical) is in the same position and has the same metrics. This similarity is greatly useful: the detailed hinting on one of these glyphs is performed, then a program maps the hints applied to the points in that glyph onto the analogous points in the other glyphs, all without the need for human intervention.

FIG. 3 illustrates a glyph classification process according to the present invention.

First, in step 130, reoccurring glyph elements are identified across the entire character set that is to be encoded. Then in step 132, the characters are grouped into classes based on the presence of glyph elements in the characters.

It should be noted, that in some cases, specific characters may belong to more than one class. This occurs where the character is composed of two or more reoccurring glyph elements.

However, care must be taken to not obscure important but subtle design effects.

FIG. 4 illustrates a set of glyphs C4, C5, C6 that were initially placed in the same class due to the presence of the radical 110 but are further subclassed according to the present invention.

At first glance, it might appear that glyphs C4, C5, C6 belong with the first set listed above. However, it can be seen that the comparatively large size of the left-hand component 112 causes the two strokes of the knife radical 110 to be moved slightly together in glyph C6. This is an important distinction that should not be lost during the hinting process. For this reason, in one embodiment, glyphs C4, C5 are placed in a different class than glyph C6.

In other embodiments, the characters are placed in different classes based on an expected number of pixels-per-EM for an expected rendering application. In still other cases, the class members are tagged classes based on whether assignments to the classes are valid for all or larger pixels-per-EM applications.

Thus, returning to FIG. 3, in step 134, the classes are further subdivided because of deviation in same elements between characters. If names were to be assigned to these classes, the first might be “right-hand knife radical” and the second might be “right-hand narrow knife radical.”

While these differences are important to maintain in the outline data, they become considerably less important when hinting the glyph down to small pixels-per-EM (ppem) sizes. At 18 ppem, for instance, the difference between the two kinds of knife radicals is completely invisible. Thus, it would be safe to create a single group for all glyphs shown.

If there are some large ppem values that would benefit from keeping the distinctions between the two kinds of knife radical, those class members can be tagged with a threshold ppem value. That would allow the software to act with the most finesse in dealing with these subtle differences.

Generally, it is desirable to share as much information and as much work as possible. Thus the use of the class mechanism as much as possible is usually desirable.

FIG. 5 illustrates a class of glyphs C7, C8, C9 that all share a “left-side earth radical” glyph element 114.

FIG. 6 illustrates a class of glyphs C7, C11, C12 that all share a “right-side ye” glyph element 116.

Note glyph C7. The first glyph C7 in both classes is the same glyph. This means that the work done on the avatar of the first class will be applied to that portion of all the glyphs in that class, while the work done on the avatar of the second class will be applied to that portion of those glyphs.

In the preferred embodiment, the list of classes is built automatically. The program looks at the outlines in a glyph and sees if any match, to within some specified tolerance, can be made any other outlines in the font. Sets of these matches are used as “seeds” for classes.

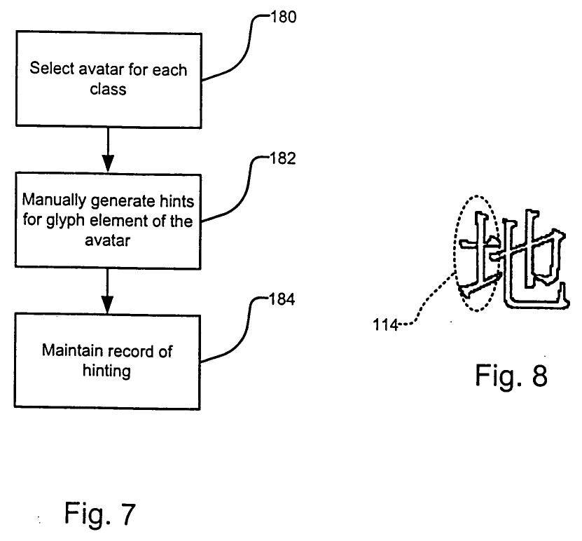

FIG. 7 illustrates the process of hinting the avatar glyph.

Once the work of building the database of classes is done, it is time to pick a single glyph from each class, called the avatar, to be hand-hinted, in step 180. Remember that a single glyph might appear in several different classes, so this is a place where judicious selection of the avatar can lessen the total number of glyphs needing hand-hinting.

In the current embodiment, the reoccurring element of the avatar glyph is “hand hinted”, or hinted by an operator in step 182. Currently, there is no real substitute for hand-hinting here. Thus, this proposal represents a hybrid approach: letting people do what they do best, but as little as possible; while letting the machine do as much as possible, building on the work that the human did.

One of the important steps in doing this hand-hinting is keeping a record of which contour or contours in the avatar are the ones to be used for the particular classes, in step 184.

FIG. 8 shows a selected avatar glyph for the “earth” glyph element 114.

Here, there are two contours, if this glyph is chosen as an avatar. It must be specified which contour corresponds to the “left-side earth radical” 114 and which one corresponds to the “right-side ye.” Having saved that information in a file will help drive the automated processing that happens in step 116 of FIG. 1.

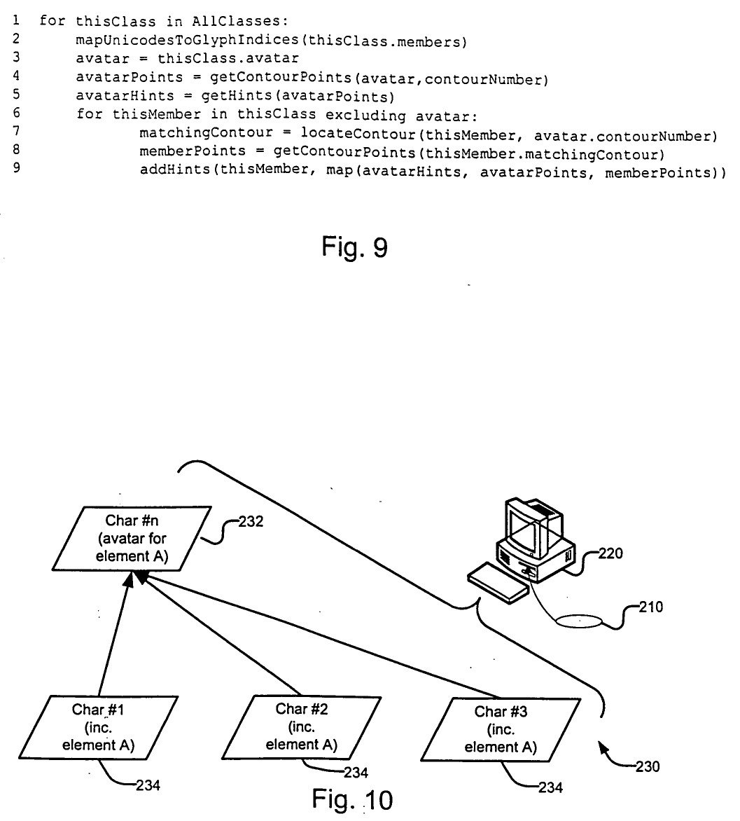

FIG. 9 is a pseudo code description of the final steps of FIG. 1.

A program looks at the class information from step A and the avatars and contour designations from step B and propagates the hints.

Line 1: Iterate over all the classes one at a time.

Line 2: Since the analysis in step 110 of FIG. 1 was done in character space, mapping all of the character codes to glyph indices in font space is required. This enable representation of the character a particular font, such as the one illustrated. Note that it might be the case that some of the character codes do not correspond to glyphs in this font. This introduces inefficiencies in the processing, so in contrast to the usual way things are done with hinting projects like this, the processing in step 116 is probably most efficiently done on a rolled-up font, rather than on individual pieces.

Line 3: Each class has exactly one avatar, as was chosen in step 116.

Line 4: Remember, in the discussion of step 116 it was noted which contour corresponded to the avatar for this class. Here the program gets the range of points in the glyph matching that contour.

Line 5: Retrieve the hints that affect the points obtained in line 4.

Line 6: Iterate over all the members of this class (except the avatar, which was already hand-hinted in step B).

Line 7: Analyze the contours in this glyph and find the one that “matches” the avatar's contour.

Line 8: Having determined the matching contour, get the set of points corresponding to it, just like the avatar.

Line 9: Add the same set of hints for this glyph that the avatar has (which was retrieved in line 5), but map the point numbers appropriately. Note that this assumes a somewhat close match; if subtle differences are present, this software will have to use heuristics to make sure an appropriate qualitative effect is applied.

After this process happens the first time, look at the output and check it. If there are only minor problems, they can be fixed by hand.

FIG. 10 illustrates the organization of a font database according to the principles of the present invention.

Generally, the previously described process for encoding font information for character-based fonts is stored typically on a recording medium such as a disk 210 that is inserted to transfer the code to a computing resource 220, such as a computer or workstation. This process results in the generation of the encoded font information 230. In one example, the hints for the reoccurring elements are only stored in association with the avatar for the class containing that element.

Specifically, in the illustrated example, the encoding information for the avatar glyph 232 for character #n comprises the hints for its element A.

Then, the other characters in the class, character #1, character #2, character #3, 234, simply contain references to the element A in the avatar 232.

This organization allows for the compression of the data required to encode the characters or glyphs. Specifically, now some of the characters do not need to contain the hint information for elements but simply refer to the hint information stored elsewhere in association with a different character.

While this invention has been particularly shown and described with references to preferred embodiments thereof, it will be understood by those skilled in the art that various changes in form and details may be made therein without departing from the scope of the invention encompassed by the appended claims.

It is claimed:

1. A method for generating hints in character-based fonts, the method comprising:
grouping characters into classes based on elements within the characters;
selecting representative, avatar characters for each one of the classes;
generating hints for the elements of the avatar characters; and
applying hints from the avatar characters to other characters in the classes.

2. The method as claimed in claim 1, wherein the characters are Chinese.

3. The method as claimed in claim 1, wherein the characters are Korean.

4. The method as claimed in claim 1, wherein the characters are Japanese.

5. The method as claimed in claim 1, wherein the grouping characters further comprises grouping characters into subclasses of the classes based on differences in the elements between the characters.

6. The method as claimed in claim 1, wherein the grouping characters comprises placing the characters in classes such that the characters in each class have a similar element.

7. The method as claimed in claim 6, wherein determining whether elements from different characters are similar is based on an expected number of pixels-per-EM for an expected rendering application.

8. The method as claimed in claim 6, wherein determining whether elements from different characters are similar is based on resolutions at which the characters will be rendered.

9. The method as claimed in claim 1, further comprising tagging members of classes based on whether assignments to the classes are valid for larger pixels-per-EM applications.

10. The method as claimed in claim 1, wherein at least some of the characters belong to more than one of the classes.

11. The method as claimed in claim 1, wherein the hints for the elements of the avatar characters are generated manually.

12. The method as claimed in claim 1, wherein the hints for the elements of the avatar characters are generated automatically.

13. The method as claimed in claim 1, further comprising confirming accuracy of the hints that are applied to the other characters in the classes.

14. A computer software product for encoding character-based fonts, the product comprising a computer-readable medium in which instructions are stored, which instructions, when read by a computer, cause the computer to:
group characters into classes based on elements within the characters;
select representative, avatar characters for each one of the classes;
generate hints for the elements of the avatar characters; and
apply hints from the avatar characters to other characters in the classes.

15. The product as claimed in claim 14, wherein the characters are Chinese.

16. The product as claimed in claim 14, wherein the characters are Korean.

17. The product as claimed in claim 14, wherein the characters are Japanese.

18. The product as claimed in claim 14, wherein the product further groups characters into subclasses of the classes based on differences in the elements between the characters.

19. The product as claimed in claim 14, wherein product places the characters in classes such that the characters in each class have a similar element.

20. The product as claimed in claim 19, wherein determining whether elements from different characters are similar is based on an expected number of pixels-per-EM for an expected rendering application.

21. The product as claimed in claim 19, wherein the product determines whether elements from different characters are similar based on resolutions at which the characters will be rendered.

22. The product as claimed in claim 19, wherein the product tags members of classes based on whether assignments to the classes are valid for larger pixels-per-EM applications.

23. The product as claimed in claim 19, wherein at least some of the characters belong to more than one of the classes.

24. The product as claimed in claim 19, wherein the product receives the hints for the elements of the avatar characters from an operator.

25. The product as claimed in claim 19, wherein the product confirms an accuracy of the hints that are applied to the other characters in the classes.

26. A font system for storing character-based font information for character-based fonts, the font system comprising:
description information for elements of avatar characters; and
references to the description information for the elements in other characters that contain similar elements.

27. The system as claimed in claim 26, wherein the description information includes hints for the elements.

28. The system as claimed in claim 26, wherein the characters are Chinese.

29. The system as claimed in claim 26, wherein the characters are Korean.

30. The system as claimed in claim 26, wherein the characters are Japanese.

31. The system as claimed in claim 26, wherein the references are specified in response to an expected number of pixels-per-EM for an expected rendering application.

32. The system as claimed in claim 26, wherein the references are based on resolutions at which the characters will be rendered.

33. The system as claimed in claim 26, wherein at least some of the characters refer to elements of different avatar characters.
